(19) United States
(12) Patent Application Publication
(10) Pub. No.: US 2004/0005178 A1
(43) Pub. Date: Jan. 8, 2004

(54) Device and method for a printing and/or copying device with reduced thermal stress on the support material

(76) Inventor: Georg Frohlich, Ottobrunn (DE)

Correspondence Address: SCHIFF HARDIN & WAITE, 6600 SEARS TOWER, 233 S WACKER DR, CHICAGO, IL, 60606-6473, US

(21) Appl. No.: 10/312,237

(22) PCT Filed: Jun. 22, 2001
(86) PCT No.: PCT/EP01/07106

(30) Foreign Application Priority Data
Jun. 23, 2000 (DE) 10030739.6

(51) Int. Cl. G03G 15/20

(52) U.S. Cl. 399/341

(57) ABSTRACT

A printing and/or copying device (10) contains a fixing unit (14, 18) with which the toner image that is transferred is fixed on the support material (28) in a first fixing state. A second fixing unit (50, 52) is then used to fix the image that has already been fixed by the first fixing unit (14, 18) in another, second fixing state according to the desired fixing characteristics. The second fixing unit (50, 52) can be configured in the form of a mechanically and or electrically couplable burn-in station.

The invention is directed to an apparatus for a printer and/or copier device, whereby the apparatus is fashioned as a burn-in station that can be coupled to the printer and/or copier device.

The invention is also directed to a printer and/or copier device having a printing unit that generates a latent image, develops it with toner and transfer-prints the developed toner image onto a carrier material. A fixing unit that fixes the transfer-printed toner image on the carrier material is arranged in the printer and/or copier device. The invention is also directed to a method for printing a carrier material.

A qualitatively high-grade and durable fixing of the toner image on the carrier is increasingly expected from modem electrographic printer and/or copier systems. The dry toners employed in electrophotography contain mainly meltable synthetic resins that melt given the application of heat. Dependent on the fixing method, the thermal energy is thereby transmitted onto the toner and onto the paper either by radiation, for example given photoflash or infrared radiation fixing, or by thermal contact, for example hot rolling or trans-fixing.

European patent application EP 0 789 860 B 1 has disclosed a multi-functional electrographic printer device for single-sided or both-sided printing of recording media in start-stop mode. This patent application as well as the U.S. Pat. No. 5,713,071 parallel thereto are herewith incorporated by reference into the present specification.

The electrographic printer devices disclosed in these patent applications have two fixing stations. The first fixing station fixes the toner image transfer-printed onto the front side of the carrier material, and the second fixing station fixes the toner image transfer-printed onto the back side of the carrier material. The fixing thereby ensues with a thermal printing fixing station having a heated fixing drum and an appertaining pressure drum. The possibility of fashioning the thermal printing fixing station with a heated or unheated admission saddle is also disclosed. The possibility of fixing with the assistance of a photoflash fixing device as well as with the assistance of a cold fixing device is also disclosed in these patent applications.

In order to achieve a high coincidence of the position of the print images on the front side and back side in duplex printing, it must be assured that the change in size of the carrier material, for example of the paper, is slight when fixing the first transfer-printed side, for example the front side. Moisture is removed from the paper due to the thermal influence during fixing, so that the paper shrinks. When the second toner image is subsequently transferred onto the other side of the paper, for example onto the back side, a size difference of the print images by the temperature-dependent, shrunken amount occurs. The paper is stressed due to the thermal influence during fixing. The heat application must be reduced in order to keep the stress for the paper low, i.e. in order to reduce the shrinkage of the paper. However, enough heat must be supplied so that the toner of the transfer-printed toner image melts and is thus fixed.

Low melting temperatures are an aim in recent developments of toners in order to be able to reduce the heat application when fixing the toner on the carrier material.

Particularly when generating printed products having enhanced demands made of the protection against counterfeiting, what is referred to as security printing, it is necessary to limit the temperature influence on the carrier material and to achieve a qualitatively high-grade fixing at the same time. In order to assure a durable adhesion of the fixed toner on the carrier material, it is necessary that so much energy be supplied to the toner that it is fluid in order to penetrate into the carrier material.

When printing self-adhesive labels and carrier material that contains integrated circuits, it is also necessary to keep the amount of heat transferred onto the carrier material low.

The following documents are referenced as further Prior Art: U.S. Pat. Nos. 5,983,064; 5,392,096; DE 35 01 303 A1; DE 32 21 059 A1; U.S. Pat. No. 4,634,257; Xerox Disclosure Journal, 17, No. 4, pp. 223-224; WO 98/27466; DE 40 36 975 A1; EP 0 107 722 B1; GB2 110597A; EP0034817A2;DE 21 30891 A1;WO 98/39691; and DE 19709 504 A1.

WO98/39691 discloses a printer or copier device for performance-adapted printing of a recording medium. The printer or copier device contains a modularly arranged fixing unit. Japanese Letters Patent JP 57201273 discloses an arrangement for fixing toner images on a carrier material. A photoflash fixing unit that is controlled dependent on the properties of the carrier material is utilized for fixing.

The document “TWO STEP FUSING PROCESS AND ACCESSORY FOR LASER PRINTERS” IBM TECHNICAL DISCLOSURE BULLETIN, IBM CORP. NEW

YORK, US, Vol. 40, No. 8, 1 August 1997 (1997-08-01), pages 23-25, XP000735565 ISSN: 0018-8689 discloses that a drum fixing and a radiant fixing be successively implemented in order to fix a toner image on a carrier material in a laser printer. Japanese Letters Patent JP 60252380 A discloses a pressing and hot-fixing unit for fixing toner images on a carrier material. The control of the pressing and hot-fixing unit ensues dependent on properties of the carrier material.

An object of the invention is to specify an apparatus and a method with which it is possible to durably fix a toner image applied onto a carrier material, so that the fixed toner image is dependably and durably connected to the carrier material even given mechanical stressing.

This object is achieved for a method by the features of patent claims 1 and 2 [ . . . ] by the features of patent claim 24. Advantageous developments are recited in the dependent claims.

Given the inventive apparatus, the burn-in station containing [ . . . ] second fixing unit can be coupled to the printer and/or copier device. For example, it can be docked to the printer and/or copier device. Alternatively, the burn-in station can be integrated in the printer and/or copier device and can preferably be replaceably detachably introduced.

The first and/or second fixing unit are designed controllable or, respectively, regulatable in view of their fixing properties. In the case of a radiant heat fixing, further, the passage distance or, respectively, the passage time can be set or, on the other hand, the intensity of the photoflash can be set given photoflash fixing. It is also possible to roll the fixed toner image in order to thus produce a gloss. Also important in multi-stage fixing is the matching of the fixing stages to one another in order to thus achieve an excellent overall fixing result and, for example, to thus enhance the fixing property of “abrasion resistance”. To this end, one of the fixing stages can also contain a moistening device. This compensates the paper stress and the paper becomes elastic. Further, an ironing effect is thus prevented or, respectively, its effect is reduced.

What is achieved by fixing a toner image transfer-printed onto a carrier material in a first fixing condition in a first fixing stage and in a second fixing condition in a second fixing stage is that the heating of the carrier material and, thus, the mechanical stressing of the carrier material is lower given the same fixing result than given a single-stage fixing. The carrier material is not stressed as much as in a single-stage fixing, which is especially advantageous given duplex printing. Temperature-sensitive carrier material such as, for example, chip cards or self-adhesive labels can be printed without damaging these carrier materials. Security elements such as impressed holograms and security films that are damaged given too great a thermal influence can also be printed with the assistance of this electrophotographic printer and/or copier device.

Given such a printer and/or copier device, toner that contains fillers with which a magneto-readable print image can be generated can also be utilized for producing the print image. Such fillers preferably contain iron or, respectively, are magnetic.

The fixing of the unprinted [sic] toner image ensues in a first stage with the assistance of the first fixing unit, whereby the transfer-printed toner image is fixed in the first fixing condition. The fixing of the toner image fixed with the assistance of the first fixing stage ensues in a second stage with the assistance of the second fixing unit, whereby the toner image is fixed in the second fixing condition. Such a two-stage fixing is also referred to below as stage fixing.

In one embodiment of the invention, the first and the second fixing unit are radiant fixing units. What is achieved as a result thereof is that the radiation emitted by the radiant fixing unit is partially reflected by light-colored carrier material, for example by white paper, and is absorbed by darkly colored toner, for example by black toner. The thermal influence on the carrier material is comparatively slight. When paper is employed as carrier material, the paper is stressed comparatively little. The employment of what is referred to as a fusing oil as employed in a thermal press fixing can be foregone given use of radiant fixing units. Given employment of a thermal press fixing as first fixing unit and/or of a thermal press fixing unit as second fixing unit, the two-stage fixing also allows the fixing temperature of these fixing units to be reduced compared to a single thermal press fixing unit in a single-stage fixing. As a result thereof, it is possible to reduce the emergence of fusing oil as a consequence of an increased need for fusing oil in the thermal press fixing.

It is also advantageous to arrange the second fixing unit of the printer and/or copier device in a separate structural unit. This establishes the possibility of retrofitting existing printer and/or copier device with a second fixing unit, whereby the performance of the fixing unit present in the existing printer and/or copier device is correspondingly adapted. There is thus also the possibility of implementing the second fixing with the assistance of this separate, second fixing unit independently of the remaining printer and/or copier device. To that end, a latent image is generated by a printing unit, it developed with toner, and the developed toner image is transfer-printed onto a carrier material, for example single sheets or continuous form material. The transfer-printed toner image is fixed in a first fixing condition with the assistance of the first fixing unit. The carrier material having the toner image fixed in the first fixing condition is, for example, stacked or rolled up dependent on the type of carrier material. In a second work process, the stacked or rolled-up carrier material is supplied to the separate structural unit and, thus, to the second fixing unit in an electrically or, respectively, mechanically coupled arrangement. This established the possibility of implementing the fixing with the assistance of the second fixing unit in a separate process independently of starts and stops of the remaining printer device. Since, particularly given radiant fixing devices, the fixing quality is dependent on a continuous transport of the carrier material and since the carrier material can be damaged due to too great a thermal influence as a consequence of a standstill of the carrier material, buffer distances, for example loop-forming devices, are preferably provided in the coupled online linking between the printer device with the first fixing unit and the second fixing unit.

In another advantageous embodiment of the invention, the electrographic printer and/or copier device also has a moistening device, a cooling device and/or a discharge device that preferably follow the second fixing unit. What is thereby achieved is that the carrier material is placed into a condition that is suitable for the further-processing of the printed carrier material.

It is also advantageous to utilize paper and/or plastic as carrier material. The carrier material can also contain self-adhesive labels or be composed of these and can also contain at least one integrated circuit. The electrographic printer and/or copier device also makes it possible to print carrier materials that would be damaged or destroyed in known electrographic printer and/or copier device as a consequence of high temperature influences and/or mechanical actions of the fixing unit. When the fixing temperature in known printer and/or copier devices is reduced, the fixing quality drops, so that the fixed toner image is easier to separate from the carrier material given mechanical influence on the carrier material and/or on the fixed toner image than given a fixing without reducing the thermal influence on the carrier material. In contrast, carrier materials that contain chip cards such as, for example, address labels with integrated, contactless chip cards for tracking shipped goods and printed products with stricter demands made of the security against counterfeiting such as, for example, flight tickets, admission tickets, checks, vouchers, motor vehicle titles and identification papers can also be produced with the inventive printer and/or copier device with high fixing quality and low thermal stressing of the carrier material. It is thereby advantageous when the second fixing unit supplies the thermal energy required for fixing to the toner without direct mechanical contact with the fixing unit. A nearly linear paper running is also advantageous.

In an advantageous development of the invention, the carrier material is printed on both sides. The toner image transfer-printed onto the front side is fixed by the first fixing unit. The toner image transfer-printed onto the back side of the carrier material is fixed by a third fixing unit. The toner image of the front side fixed by the first fixing unit is fixed by the second fixing unit, and the toner image of the back side fixed by the third fixing unit is fixed by a fourth fixing unit, whereby the second and the fourth fixing unit can simultaneously fix the front side and the back side of the carrier material in the second fixing condition. It is thus possible to also effectively utilize the invention in duplex printing, namely in vertical and horizontal arrangement.

In another advantageous embodiment of the invention, a temperature-regulated guide path or, respectively, temperature compensation path is provided preceding the second fixing unit or, respectively, preceding the second and/or fourth fixing unit. What is thereby achieved is that the carrier material is supplied to the second and/or to the fourth fixing unit with a pre-defined temperature, and a constant fixing quality is thus achieved. This guide path also prevents too great a heat quantity from being stored in the carrier material, this having been supplied to the carrier material by the first and/or third fixing unit and producing a temperature in the carrier material [ . . . ] the heat quantity supplied to the carrier material by the second and/or fourth fixing unit that damages or destroys the carrier material.

The fixing of the toner image transfer-printed onto the carrier material in two stages achieves a high fixing quality. The vitrification (melting) of the toner material is controlled in defined fashion during the fixing processes in stages and is thus specifically matched to the glass transition point, which is dependent on the toner material. The toner material becomes sticky and begins to melt at the glass transition point. The heating of the carrier in the fixing event given stage fixing is lower given the same fixing quality than given a fixing with the assistance of a single fixing unit. Dependent on the type and temperature sensitivity of the carrier material, it is advantageous to regulate the heat quantity generated by the fixing units and/or the temperatures of the fixing units. Carrier materials that are composed of temperature-sensitive materials and/or contain such materials such as, for example, labels or credit cards can thereby also be printed with high quality. Further, thickness difference of the labels that are glued on, printed and to be fixed can be compensated without negative influence on the adhesive force of the adhesive surfaces.

Further features and advantages of the invention derive from the following description that explains the invention on the basis of an exemplary embodiment in combination with the attached drawings. Shown are:

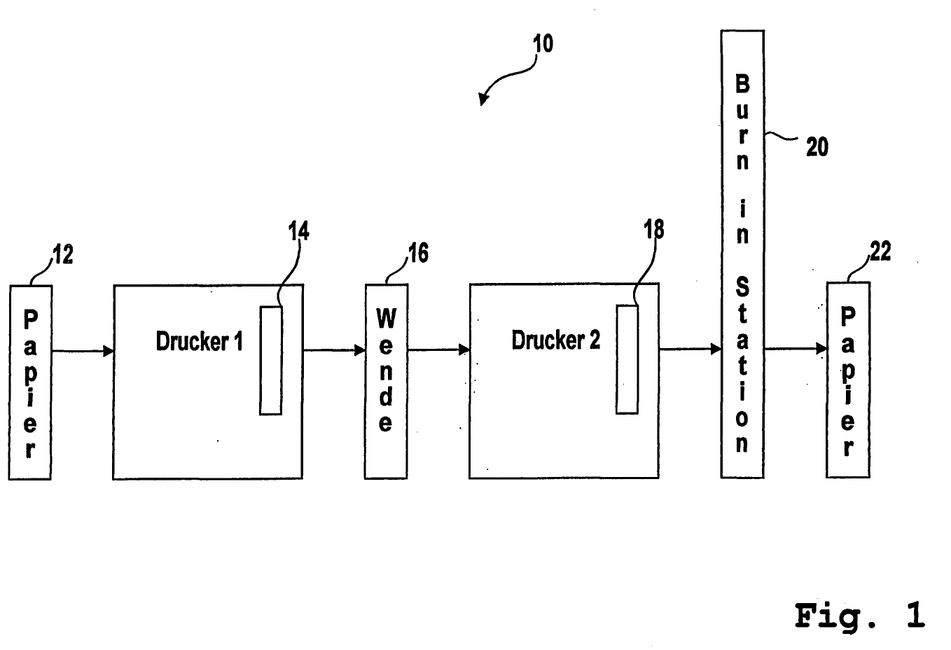

FIG. 1 an inventive printer and/or copier device that contains two printers as well as a separate burn-in station;

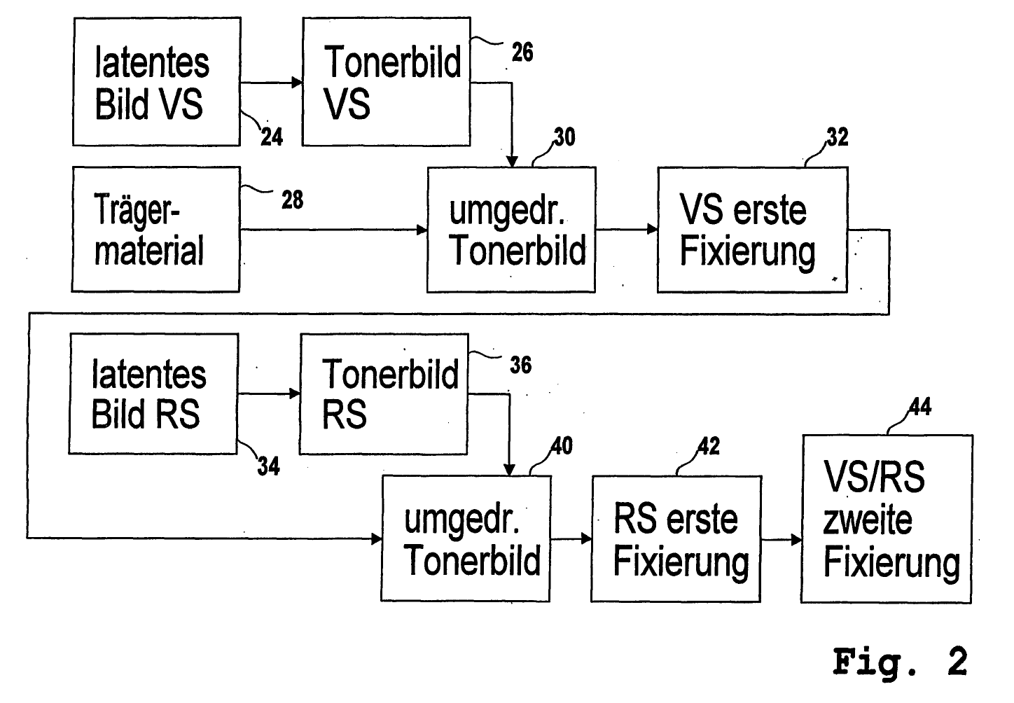

FIG. 2 a schematic overview of the process steps for generated a carrier material printed on both sides with an arrangement according to FIG. 1;

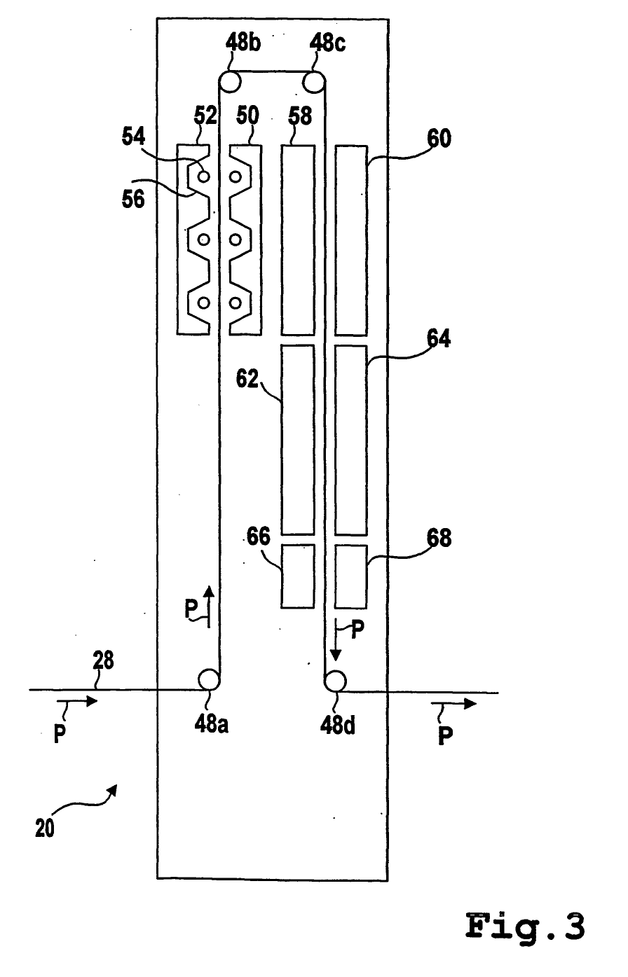

FIG. 3 the schematic structure of the burn-in station from FIG. 1;

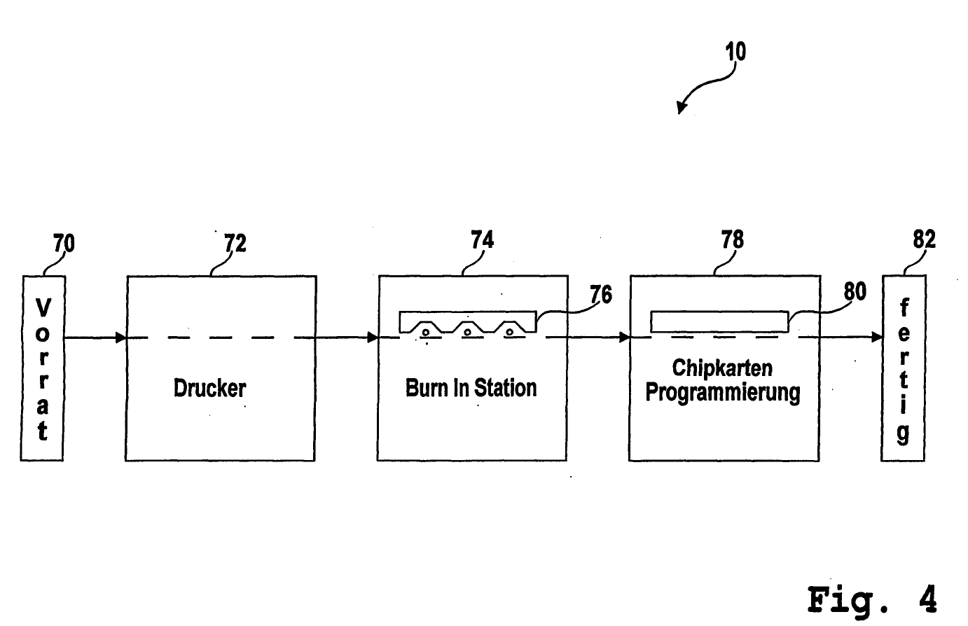

FIG. 4 an inventive printer and/or copier device for single-sided printing of carrier material, whereby the integrated circuits contained in the carrier material are programmed in a further structural unit;

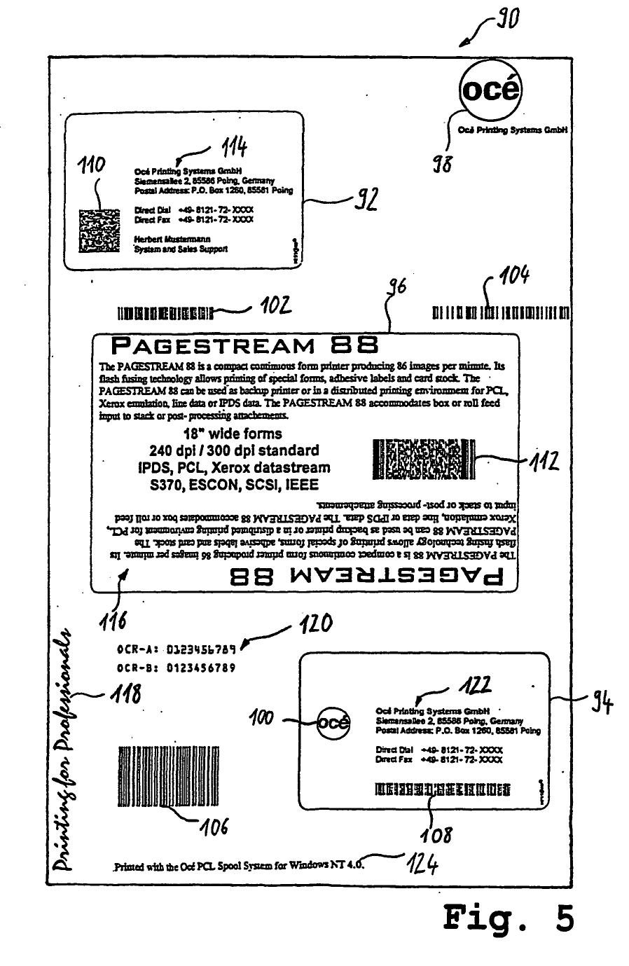

FIG. 5 a print page that contains various carrier materials;

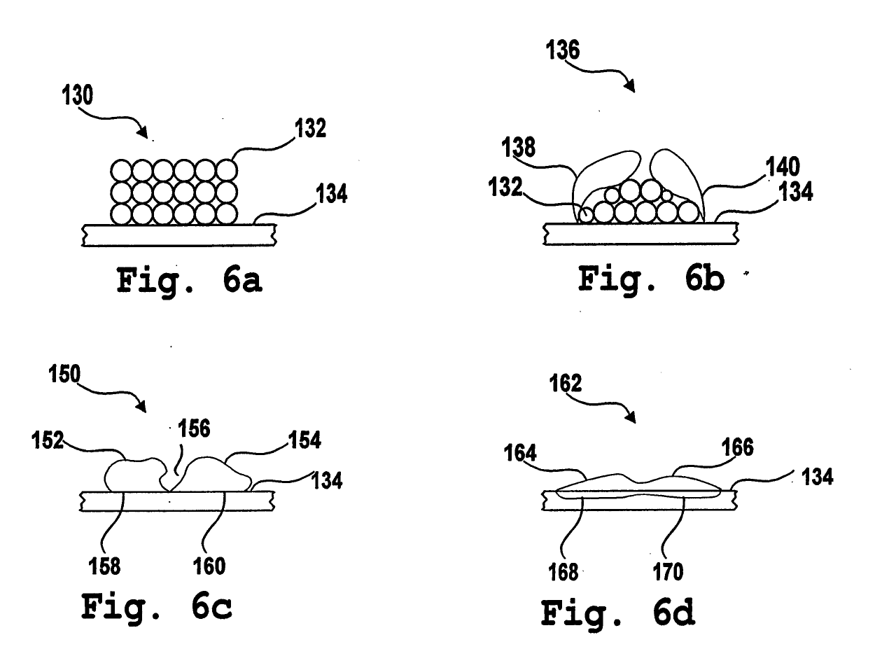

FIGS. 6a-6d a schematic illustration of the toner image and of the carrier material during the fixing event;

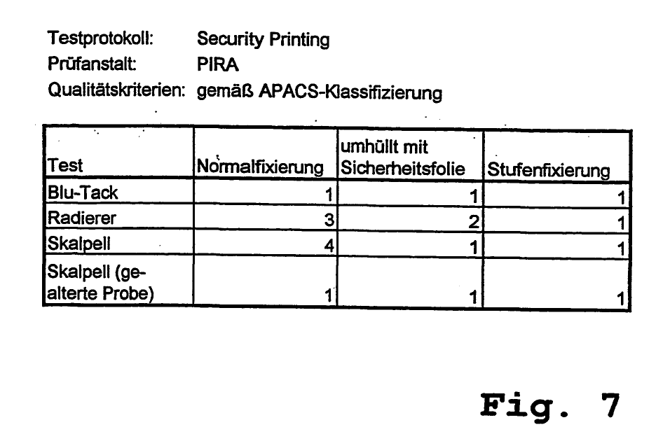

FIG. 7 a table with results of a test protocol of the PIRA Testing Institute of toner images fixed on paper according to APACS testing guidelines (class 1-2) for printed products with stricter demands made of the security against counterfeiting and of the durability that have been fixed with the second fixing unit of an electrographic printer device; and

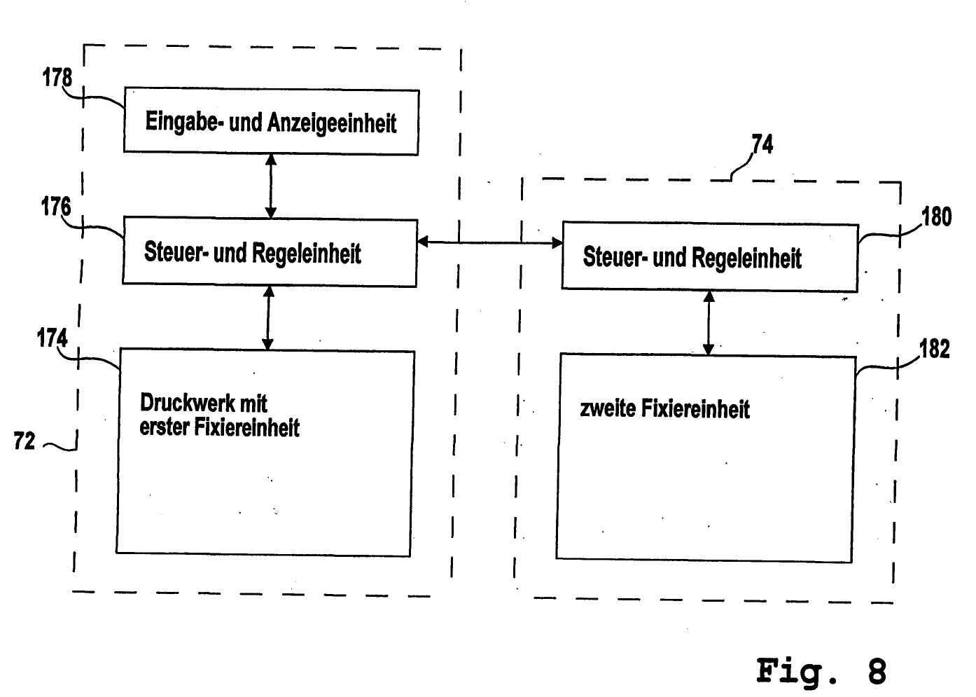

FIG. 8 a block circuit diagram in which the collaboration of the control and regulating units of the printer and of the burn-in station is shown.

FIG. 1 shows an inventive printer and/or copier device 10 that has two printers, what is referred to as a twin station, and a separate structural unit 20 in which a second and fourth fixing unit are arranged. Paper is utilized as carrier material in this exemplary embodiment. The carrier, however, can also contain or be composed of films, plastics, for example chip cards, self-adhesive labels as well as integrated circuits. The paper is located in a paper supply 12. In this exemplary embodiment, the paper supply 12 contains a paper stack of continuous form paper with transport holes and perforations that contains self-adhesive labels. This continuous form paper is suppled to the printer 1. However, paper as individual sheets or in roll form with and without perforation as well as with and without transport holes can also be utilized as carrier material. The printer 1 is also connected to a calculating unit (not shown) that communicates print data to the printer 1 for printing the front side of the paper. The printer 1 generates a latent image of the front side, develops this image by inking with toner, transfer-prints this toner image onto the paper and fixes it with the assistance of a first fixing unit 14, a photoflash fixing unit, in a first fixing condition. The paper with the fixed front side is supplied to turning device 16 that turns the paper by 180° and supplies it to a printer 2.

The structure of the printer 2 is identical to that of the printer 1. The printer 2 is likewise connected to the calculating unit (not shown) and receives print data from it from which it generates a latent image of the page side, inks this with toner, trans-prints this onto the back side of the paper and fixes it in a first fixing condition with a third fixing unit 18. The paper printed on both sides in this way is supplied to a separate structural unit 20, what is referred to as the burn-in station. A second and a fourth fixing unit are arranged in the burn-in station 20, whereby the second fixing unit is provided for fixing the front side of the paper and the fourth fixing unit is provided for fixing the back side of the paper.

The second and the fourth fixing unit are radiant heat fixing unit that irradiate the paper, particularly the toner image on the paper, with infrared radiation and thus fix it in a second fixing condition. Further devices such as, for example, a moistening device, a cooling device and a discharge device are arranged in this burn-in station, these influencing the paper such that the paper leaves the burn-in station 20 with predefined parameters. These further devices are driven by a controller (not shown) that assures the pre-defined parameters of the paper with the assistance of a regulator.

Subsequently, the paper is supplied to a stacking device 22 or, respectively, to a roll-up device. The air path between printer 2 and the burn-in station 20 serves as cooling distance for the paper, so that the paper is supplied to the second and to the fourth fixing unit in the burn-in station 20 with a temperature that is constant in a prescribed range. In other exemplary embodiments, however, it is possible that the burn-in station 20 together with the printing units and fixing stations 14, 18 of the printers 1 and 2 form a structural unit, i.e. are arranged in one housing.

FIG. 2 shows a schematic overview directed to the inventive generation of a carrier material printed on both sides. A latent image 24 of the front side is generated from print data in the printer 1 with the assistance of a known electrographic method, a toner image 26 of the front side being subsequently generated from said latent image 24 with the assistance of a known developer unit. The printer 1 is also supplied with carrier material 28, for example paper, onto which the toner image of the front side 12 is transfer-printed to form a transfer-printed toner image 30. The paper 28 with the transfer-printed toner image 30 is supplied to the first fixing unit 14 of the printer 1, which fixes the transfer-printed toner image 30 of the front side in a first fixing condition 32. The quantity of heat output by the first fixing unit 14 and, thus, the temperature of the carrier material is regulated dependent on the preset type and temperature sensitivity of the carrier material.

A latent image 34 of the back side is generated from print data in the printer 2 with the assistance of a known electrographic method, is inked with toner be a known developer unit to form a toner image 36 of the back side, and is transfer-printed with the assistance of a known transfer-printing device onto the back side of the paper 28 printed by the printer 1 to form a transfer-printed toner image 40. The transfer-printed toner image 40 of the back side is fixed in a first fixing condition in the third fixing unit 18 of the printer 2. The quantity of heat output by the fixing unit 18 and, thus, the temperature of the carrier material is regulated dependent on the preset type and temperature sensitivity of the carrier material. The paper 28 printed on both sides is supplied to the burn-in station 20.

In the burn-in station 20, the toner image 32 of the front side fixed in the first fixing condition and the toner image 42 of the back side fixed in the first fixing condition are fixed in a second fixing condition 44 with the assistance of a second and a fourth fixing unit.

FIG. 3 shows the schematic structure of the burn-in station 20 for both-sided, simultaneous fixing of the front side and back side of the paper 28. With the assistance of guide and drive rollers 48a, 48b, 48c, 48d, the paper 28 is supplied in the direction of the arrow P in conformity with the printing speeds of the printers 1 and 2. A second fixing unit 50 fixes the toner image 32 located on the paper into the second fixing condition 44, said toner image 32 having been fixed by the first fixing unit 14. A fourth fixing unit 52 fixes the toner image 42 of the back side into the second fixing condition, said toner image 42 having been fixed in the first fixing condition with the third fixing unit 18 (FIG. 1).

The fixing device 50, 52 are radiant heat fixing devices and contain six quartz heating rods at each side that are interchangeably designed and individually drivable in groups, one thereof being referenced 54. The quartz heating rods 54 are connected to a voltage supply unit (not shown). Corresponding to a signal of a controller (not shown), the calorific output of the quartz heating rods 54 is regulated on the basis of the transport velocity of the paper 28 and on the preset type and temperature sensitivity of the paper 28. The radiant heat output by the quartz heating rods 54 is partially reflected by reflectors (one thereof being referenced 56) such that the radiant heat is supplied to the paper 28. The radiant heat is absorbed by the toner, particularly given dark toner.

The white surfaces of the paper 28 partially reflect the incident radiant heat of the quartz heating rods 54. The fixing energy is thus mainly supplied to the toner of the toner image 32, 42. The toner is heated such that it is liquid and penetrates into the paper fibers of the paper 28. The penetration is promoted by the capillary action of the paper 28. Given toners that contain particles that do not melt during fixing, for example given MICRA toners, a part of the toner penetrates into the paper 28. The non-melting particles are embedded in the molten part of the toner on the paper surface. Even given high mechanical stressing, the toner is thus firmly joined to the paper 28. Instead of the radiant fixing units 50, 52, correspondingly adapted thermal press fixing units with or without pre-heating saddle, photoflash fixing units or transfix fixing units can also be utilized.

The use of a cold fixing device is technically conceivable; however, a cold fixing device should not be utilized for environmental reasons. Particularly given dark toners, however, it is meaningful to utilize radiant fixing units such as radiant heat fixing units and photoflash fixing units in order to keep the heating of the paper 28 low.

After the fixing of the paper 28 by the fixing units 50, 52, the paper 28 is conducted past moistening devices 58, 60, past cooling devices 62, 64 and past discharge devices 66, 68. The moistening devices 58, 60, the cooling devices 62, 64 and the discharge devices 66, 68 serve the purpose of assuring that the printed paper 28 has pre-defined parameters after leaving the burn-in station 20 that facilitate or, respectively, do not impede the further-processing of the printed paper 28, for example the stacking or, respectively, roll-up of the paper 28 with the assistance of the paper stacker or, respectively, roll-up device 22 or the separation with a cutter.

The second and fourth fixing unit 50, 52, the moistening devices 58, 60, the cooling devices 62, 64 and the discharge devices 66, 68 are vertically arranged in the burn-in station. As a result thereof, the heat of the second and fourth fixing unit 50, 52 can escape by natural convection, for example given a standstill of the carrier material 28. The linear vertical paper guidance in the burn-in station 20 with the following cooling distance that contains the moistening device 58, 60, the cooling device 62, 64 and the discharge device 66, 68 enables a guidance of the carrier material 28 with low friction as a result of the deflection rollers 48a through 48d and, thus, with little static charging and good smoothing of the carrier material 28.

The replaceably contacted quarts heating rods 54 are arranged transverse relative to the conveying direction of the carrier material 28. However, a width-dependent arrangement of the quartz heating rods along the conveying direction of the carrier material 28 is also possible. The power of the quartz heating rods 54 is set and/or regulated dependent on the type and transport velocity of the carrier material 28.

FIG. 4 shows an inventive printer and/or copier device 10 for single-sided printing of carrier material 28, whereby the chip cards contained in the carrier material 28 are programmed in a structural unit 78 of the printer and/or copier device 10. The printer or copier device 10 has a carrier material supply 70 from which carrier material 28 is supplied to a printer 72 for printing, whereby a toner image transfer-printed onto the carrier material 28 by the printer 72 is fixed in a first fixing condition by a fixing unit (not shown) arranged in the printer 72.

The carrier material 28 printed by the printer 72 is supplied to the burn-in station 74, which contains a second fixing unit 76. The fixing unit 76 is preferably a radiant fixing unit that has the same structure as the radiant fixing units 50, 52 previously described in FIG. 3. The fixing unit 76 fixes the toner image on tha carrier material 28 in a second fixing condition. The carrier material 28 fixed in this way is supplied to a further structural unit 78. A chip card programming device 80 is arranged in the structural unit 78. With the assistance of the chip card programming device 80, the integrated circuits that are contained in the carrier material 28 and that are suited for wireless data communication with data processing systems and/or controllers are programmed when they pass by the chip card programming device 80.

After the programming of the integrated circuits, the printed carrier material is sent to pre-designated recipients, whereby it is packaged ready for shipping in a shipping device 82. However, the printed carrier material can also be supplied to further structural units for further-processing, for example to a cutter device.

FIG. 5 shows a print page 30 that has been printed by the inventive printer and/or copier device 10 of FIG. 4 and the integrated circuits contained therein have been programmed. A paper stack of continuous form paper with transport holes and perforations is situated in the carrier material supply 70 (FIG. 4), one print page 90 thereof being shown in FIG. 5. Just like the other print pages of the carrier material supply 70, this print page 90 contains chip cards 92, 94 that are manufactured of a plastic material, contain integrated circuits and are secured on the paper of the print page 90 with the assistance of adhesive. The integrated circuits contained in the chip cards 92, 94 can wirelessly communicate with data processing systems and/or controllers, so that no contacts are conducted out from these chip cards.

The print page 90 also has a self-adhesive label 96 that is pulled off from the print page 90 and glued onto other suitable surfaces, for example onto cardboard cartons of packages or onto housing parts of devices, with the assistance of the adhesive situated on the pulled-off part of the self-adhesive label 96. The printer 72 receives print data from a data processing system (not shown). With the assistance of these print data, the printer 72 produces a latent image that it inks with toner with the assistance of a known developer unit, transfer-prints onto the print pager 90 as well as onto the chip cards 92, 94 and the self-adhesive label 96 and fixes in a first fixing condition with the assistance of a first fixing unit.

The carrier material 90, 92, 94, 96 printed on one side in this way is supplied to the burn-in station 74, which fixes the toner image in a second fixing condition. The circuits contained in the chip cards 92, 94 are programmed with the data intended for this print job by the chip card programming device 80 in the device 78. The printed print page 90 contains a plurality of graphics 98, 100, bar codes 102, 104, 106, 108, security elements 110, 112, as well as a plurality of text blocks 114, 116, 118, 120, 122, 124. The reading of the bar codes 102, 104, 106, 108 as well as of the security elements 110, 112 with the assistance of known reader systems is not negatively affected by the fixing in two stages.

FIGS. 6a through 6d schematically show the fixing event of the toner image transfer-printed onto the carrier material. In FIG. 6a, a transfer-printed, non-fixed toner image 130 in the form of toner powder 132 is situated on a carrier material 134, for example paper.

FIG. 6b shows a partially fixed toner image 136 that is situated on the paper 134 during the fixing event in the first fixing unit. This fixing ensues with the assistance of a photoflash fixing unit. However, other fixing units, for example radiant heat fixing units or thermal press fixing units, can also be utilized as first fixing unit. The toner powder 132 is supplied with thermal energy by the first fixing unit. As a result of this application of heat, a part of the toner powder 132 that faces toward the fixing unit is melted. Superficially closed regions 138, 140 of molten toner thereby arise.

FIG. 6c shows a toner image 150 fixed in the first fixing condition. The toner powder 132 has completely fused to form interconnected toner regions 152, 154 that form an uneven surface with what are referred to as craters 156. The molten toner 152, 154 has contacting surfaces 158, 160 with the paper 134 that see to an adhesion of the toner 152, 154 sufficient for standard printing quality after the fixing in the first fixing condition at the paper 134. Given high mechanical stressing of the paper 134, however, the toner can potentially separate from the paper.

FIG. 6d shows a fixed toner image 162 that has been fixed in the second fixing condition with the assistance of the burn-in station 20, 72. The toner image 150 fixed in the first fixing condition is fixed in a second fixing condition with the assistance of the second fixing units 50, 52, 76 arranged in the burn-in stations 20, 74. The second fixing unit 50, 52, 76 is preferably a radiant heat fixing unit. The use of other fixing units is conceivable. The toner 152, 154 fixed in the first fixing condition is melted again, whereby the second fixing unit 50, 52, 76 supplies so much thermal energy to it that it is fluid and can penetrate into the paper 134.

The toner fixed in the second fixing condition forms regions 164, 166 that are situated on the paper 134 and regions 168, 170 that have penetrated into the paper 134 and firmly join the fixed toner 164, 166 to the paper 134. the toner fixed in this way remains firmly joined to the paper 134 even given hard mechanical stressing of the paper 134 and/or of the fixed toner 164, 166. Given print pages that have been fixed in two stages with the inventive printer and/or copier device, a durability and permanence of the print image as only achieved in the Prior Art with impact printers was documented.

FIG. 7 shows a table with results of a test protocol of the PIRA Testing Institute. Toner images fixed on paper 28, 134 that had been produced with the inventive printer and/or copier device 10 were investigated according to the testing guidelines for printed products having stricter demands made of the security against counterfeiting and of the durability. The names of the implemented tests are recited in the first column in the table of FIG. 7. Further, the results of an investigated print page that had been produced with the assistance of a known printer and/or copier device are recited in the column “normal fixing”. Further, a print page was investigated that had been produced with a known printer and/or copier device and that was coated with a security film. The results of the test of this print page are recited in the column of the table labelled “enveloped with security film”. The test results of the print page that had been produced with the inventive printer and/or copier device are listed in the table column “stage fixing”.

The print page produced with the known printer and/or copier device and that what are referred to as fixed with the assistance of a single fixing unit exhibits considerable deficiencies in the eraser and in the scalpel test. Such a print page does not meet the stricter demands made of the security against counterfeiting and/or the durability of the print page. When a print page produced with a known printer and/or copier device is enveloped with a security film, the properties of this print page are improved and more secure against counterfeiting compared to the print page without security film. An improvement was especially registered in the scalpel test, so that this print page enveloped with the security film passed this scalpel test.

In the erasing test, however, the print page enveloped with the security film exhibited deficiencies. A print page produced with the inventive printer and/or copier device exhibited no deficiencies with respect to the durability and the security of the print page in the tests that were implemented. The test results are list in the table column “stage fixing”. An additional enveloping of this print page with the security film for reasons of durability and security can be foregone. The print pages that had been fixed in two stages with the inventive printer and/or copier device revealed a durability and a permanence of the print image that was only achieved in the Prior Art using impact printers.

What the stage-by-stage fixing of the toner image on the carrier material 28 in a first and in a second fixing condition achieves is that the heating of the carrier material 28 and, thus, the temperature stress on the carrier material 28 is lower given the same fixing result than in a known single-stage fixing.

Temperature-sensitive carrier material 28 such as, for example, films impressed with a hot-imposing method, self-adhesive labels and plastics can be printed without damaging these carrier materials 28. Integrated circuits that are contained in the carrier material 28 are also not damaged or destroyed as a result of the lower temperature stressing of the carrier material 28. The printing of thermally sensitive surfaces and thermally sensitive carrier materials 28 is thus also possible.

The surface of the toner image is smoother with the assistance of the second fixing event. Given print images that, for example, contain pixel graphics, one-dimensional or two-dimensional bar codes, there is no negative influence due to the second fixing, particularly in the sharpness of the presentation and the edge smoothing. An inventive stage fixing without noticeable deterioration of the generated print image is possible given the use of toners with an iron constituent, what is referred to as MICRA toner, for generating magnetically readable print images

The toner application on the carrier material 28 is reduced due to the farther-reaching melting process of the toner on the fixing of the toner image in the second fixing process wherein the toner penetrates into the carrier material 28. Particularly given printed products that contain a plurality of pages such as, for example, books, it is thereby possible to reduce the different thickness of the printed regions and the non-printed regions of the print pages. The arcs of such a printed product as a result of this different thickness can be reduced, as a result whereof the optical appearance of such a printed product can be considerably improved.

Due to the penetration of the toner into the carrier material 28, the fixing of the toner in the second fixing condition also leads to an improved adhesion and enhanced resistance to aging of the toner on the carrier material 28 and to a uniform surface of the fused toner, as a result whereof a more uniform degree of blackening is achieved. The toner concentration in the developer unit and, thus, the toner quantity on the regions of the carrier material 28 inked with toner can be reduced since a uniform degree of blackening of these regions is assured due to the fusing of the toner into the carrier material 28.

FIG. 8 shows a block circuit diagram that shows the collaboration of the control and regulating units of the printer 72 and of the burn-in station from FIG. 4. The printer 72 has a control and regulating unit 176 that is connected to an input and splay unit 178 as well as to the printing unit 174 of the printer 72. The burn-in station 74 has a control and regulating unit 180 for the control and regulation of the second fixing unit 182. The control and regulating units 176, 180 are connected to one another via a bus connection. A data exchange between the control and regulating unit 176 of the printer 72 and the control and regulating unit 180 of the burn-in station 74 occurs with the assistance of this bus connection. The input and display unit 178 serves as man-machine interface that enables an operator to preset printing and fixing parameters. In this applied example, the input and display unit 178 is a touch screen that is permanently installed in the housing of the printer 72.

Before the start of the print job, the operator sets the temperature sensitivity and the type of carrier material 28 at the input and display unit 178 of the printer 72. Corresponding to this presetting, the control and regulating unit 176 selects rated values for the regulation of the temperature and/or of the heat quantity of the first and of the second fixing unit. The rated value of the second fixing unit is handed over to the control and regulating unit 180 of the burn-in station 74 via the data bus connection. Given changing process conditions, for example given a change in the paper moisture and/or the paper temperature, increase of the ambient temperature in the printer, the control and regulating unit 176 of the printer 72 can correct these rated values, taking the preset type and temperature sensitivity of the carrier material 28 into consideration.

The control and regulating unit 180 of the burn-in station 74 regulates the performance of the second fixing unit 182 dependent on the transport velocity of the carrier material 28. When the second fixing unit 182 is, for example, a radiant fixing unit with quartz heating rods 54, then the regulation of the calorific output of the quartz heating rods 54 can be undertaken with the assistance of phase-controllable control. However, there is also the possibility of presetting the supply voltage or the supply current of the quartz heating rods 54, preferably with the assistance of a regulatable power supply unit.

Further, a temperature sensor is arranged in the second fixing unit 182, this acquiring the temperature in the fixing unit and/or the temperature of the carrier material 28, whereby the calorific output of the second fixing unit 182 is reduced or, respectively, pivotable and controllable flaps or blinds protect the recording carrier given upward transgression of the temperature permitted for the carrier material 28.

List of Reference Characters

10 printer and/or copier device

12 paper supply

14 fixing unit

16 turning device

18 fixing unit

20 burn-in station

22 stacking device

24 latent image—front side

26 toner image—front side

28 carrier material (paper)

30 transfer-printed toner image—front side

32 first fixing condition—front side

34 latent image—back side

36 toner image—back side

40 transfer-printed toner image—back side

42 first fixing condition—back side

44 second fixing condition—front side and back side

48a-48d guide and drive rollers

50 second fixing unit (front side)

52 fourth dixing [sic] unit (back side)

54 quarts heating rod

56 reflector

58, 60 moustening [sic] devices

62, 64 cooling devices

66, 68 discharge devices

70 carrier material supply

72 printer

74 burn-in station

76 second fixing unit

78 further structural unit

80 chip card programming device

82 shipping device

90 print page

92, 94 chip cards

96 self-adhesive label

98, 100 graphic

102-108 bar codes

110, 112 security elements

114-124 text blocks

130 transfer-printed toner image

132 toner powder

134 paper

136 partially fixed toner image

138, 140 fused toner

156 crater

158, 160 contacting surfaces

162 toner image in the second fixing condition

164, 166 rager [sic] regions on the paper

168, 170 toner regions in the paper

174 printing unit with first fixing unit

176, 180 control and regulating unit

178 input and display unit

182 second fixing unit

P arrow in conveying direction of the carrier material

1. Apparatus for a printer and/or copier device to which a carrier material (28) with a toner image transfer-printed onto the carrier material (28) and already fixed on the carrier material (28) with a first fixing unit (14, 18) can be supplied, whereby
a) the apparatus is fashioned as a burn-in station (20) that can be electrically and/or mechanically coupled to the printer and/or copier device, said burn-in station comprising a second fixing unit (14, 18) that fixes the image fixed in a first fixing condition (32, 42) on the carrier material (28) by the first fixing unit (14, 18) into a second fixing condition (44),
b) the second fixing unit (50, 52) is designed controllable with respect to its fixing properties, and
c) a cooling distance is arranged preceding the second fixing unit.

2. Printer and/or copier device
comprising a printing unit that generates a latent image, develops it with toner and transfer-prints the developed toner image onto a carrier material (28), having a first fixing unit (14, 18) that fixes the transfer-printed toner image in a first fixing condition (32, 42) on the carrier material (28),
having a second fixing unit (50, 52) that fixes the image fixed by the first fixing unit (14, 18) in a second fixing condition (44),
whereby at least one of the fixing units (14, 18, 50, 52) is designed controllable with respect to its fixing properties, and
whereby a cooling distance is arranged preceding the second fixing unit.

3. Apparatus according to one of the claims 1 or 2, characterized in that at least the second fixing unit (50, 52) is a radiant fixing unit.

4. Apparatus according to claim 3, characterized in that the radiant fixing unit (14, 18, 50, 52) is a photoflash fixing unit.

5. Apparatus according to one of the preceding claims, characterized in that the second fixing unit (50, 52) is arranged in a structural unit (20) separate from the printer device and the first fixing unit (14, 18).

6. Apparatus according to one of the preceding claims, characterized in that the printer and/or copier device (10) also contains a moistening device (58, 60), and/or a cooling device (62, 64) and/or a discharge device (66, 68).

7. Apparatus according to one of the preceding claims, characterized in that the carrier material (28) contains plastic and/or plastic (92, 94).

8. Apparatus according to claim 7, characterized in that the carrier material (28, 90, 92, 94, 96) contains at least one active and/or passive circuit.

9. Apparatus according to claim 7 or 8, characterized in that the carrier material (29) comprises self-adhesive labels (960 or is composed of self-adhesive labels (92).

10. Apparatus according to one of the preceding claims, characterized in that the printed products (90, 92, 94, 96) that are produced have stricter demands made of the protection against counterfeiting and/or of the adhesion of the toner application.

11. Apparatus according to claim 10, characterized in that the fixed image exhibits a firm union with the carrier material (28, 90, 92, 94, 96), particularly in a blu-tack test, an erasing test and a scalpel test.

12. Apparatus according to one of the preceding claims, characterized in that the toner image is transfer-printed page-by-page, whereby each transfer-printed toner image is fixed by the first and by the second fixing unit (14, 18, 50, 52).

13. Apparatus according to one of the preceding claims, characterized in that each toner image is fixed by at least two fixing devices (14, 18, 50, 52) that are separate from one another.

14. Apparatus according to one of the preceding claims, characterized in that, in a duplex printing, the toner image transfer-printed onto the front side of the carrier material (28) is fixed by the first fixing unit (14); in that a toner image transfer-printed onto the back side of the carrier material (28) is fixed by a third fixing unit (18); in that the toner image of the front side fixed by the first fixing unit (14) is fixed by the second fixing unit (50); and in that the toner image of the back side fixed by the third fixing unit (18) is fixed by a fourth fixing unit (52).

15. Apparatus according to claim 14, characterized in that the toner image of the back side is transfer-printed and fixed by the third fixing unit (18) after the toner image of the front side is transfer-printed and fixed.

16. Apparatus according to one of the claims 14 or 15, characterized in that the toner images of the front side and back side are simultaneously fixed by the second and the fourth fixing unit (50, 52).

17. Apparatus according to one of the claims 14 through 16, characterized in that the first and/or the third fixing unit (14, 18) supplies so much thermal energy to the toner image and to the carrier material (28) that the toner of the toner image melts and unites with the surface of the carrier material (28).

18. Apparatus according to one of the claims 14 through 17, characterized in that the second and/or the fourth fixing unit (50, 52) supples so much thermal energy to the toner image and the carrier material (28) that the toner of the toner image melts and penetrates into the carrier material (28).

19. Apparatus according to one of the claims 14 through 18, characterized in that the heat transfer from the first, second, third and/or fourth fixing unit (14, 18, 50, 52) onto the toner image ensues without applying force onto the toner image and onto the carrier material (28).

20. Apparatus according to one of the claims 14 through 19, characterized in that the second and/or the fourth fixing unit (50, 52) is accommodated in a separate housing (20, 74).

21. Apparatus according to one of the claims 14 through 20, characterized in that a cooling distance is provided preceding the second and/or fourth fixing unit (50, 52).

22. Apparatus according to one of the preceding claims, characterized in that the printer and/or copier device (10) has two successively arranged printing units with a respective, internal fixing unit (14, 18) for fixing the print image generated by the printing unit as well as at least one further, separate fixing unit (50, 52) following the printing units.

23. Apparatus according to one of the preceding claims, characterized in that the properties of the carrier material (28), particularly the type and temperature sensitivity of the carrier material (28), can be set at an input and display unit (178) of the printer and/or copier device (10).

24. Apparatus according to one of the preceding claims, characterized in that the printer and/or copier device (10) has at least one control and regulating unit (176, 180) that regulates the heat quantity supplied to the carrier material by the first and/or second fixing unit dependent on the type and temperature sensitivity of the carrier material (28).

25. Method for printing a carrier material,
whereby a toner image is transfer-printed onto a carrier material (28),
the transfer-printed toner image is fixed in a first fixing condition on the carrier material (28) in a first fixing stage (14, 18),
the image fixed in the first fixing stage (50, 52) is fixed in a second fixing condition in a second fixing stage (50, 52),
the fixing in at least one of the fixing stages (14, 18, 50, 52) is designed controllable with respect to its fixing properties, and
whereby a cooling distance is provided preceding the second fixing stage.

26. Fixing device (50, 52) for fixing toner images on a carrier material (28) according to one of the claims 1 through 24.
